(19) United States
(12) Patent Application Publication
(10) Pub. No.: US 2009/0315447 A1
(43) Pub. Date: Dec. 24, 2009

(54) LIGHT SOURCE COMPRISING A SATURATED COLOR APPEARANCE

(75) Inventors: Stephan Appel, Augsburg (DE); Armin Konrad, Grobaitingen (DE)

Correspondence Address: FRISHAUF, HOLTZ, GOODMAN & CHICK, PC, 220 Fifth Avenue, 16TH Floor, NEW YORK, NY, 10001-7708, US

(73) Assignee: OSRAM Gesellschaft, Munchen (DE)

(21) Appl. No.: 12/309,509

(22) PCT Filed: Jul. 19, 2007
(86) PCT No.: PCT/EP2007/057457

§ 371 Date: May 7, 2009

(30) Foreign Application Priority Data
Jul. 24, 2006 (DE) 10 2006 034 147.3

(51) Int. Cl. H01J 61/40

(52) U.S. Cl. 313/485

(57) ABSTRACT

The invention relates to a light source, especially a fluorescent lamp, comprising at least one bulb, a silicon rubber which is resistant to high temperatures being arranged on the bulb. Said silicon rubber is provided with at least one pigment influencing the colour appearance and light saturation in order to generate a saturated colour appearance.

### TECHNICAL FIELD

The invention relates to a light source, in particular a fluorescent lamp, with at least one lamp vessel.

### PRIOR ART

It is known from the general prior art to provide corresponding pigment underlayers as color filters between the lamp vessel and the phosphor layer in order to produce light spectra in different color regions. These pigment underlayers absorb the undesirable components in the light spectrum of the lamp, with the result that the desired color locus, for example a yellow color locus in the case of NiSbTiO₂ pigments or a red color locus when using Fe₂O₃ pigments, is achieved. A first disadvantage with such light sources is the fact that the pigment underlayer absorbs a large proportion of the optical radiation and as a result reduces the efficiency of the fluorescent lamp and a second disadvantage is the fact that the coating process for producing the pigment underlayer is complex and cost-intensive. It has further been shown that the filter effect of the pigment underlayers of such lamps often do not meet the stringent requirements for color saturation. A further disadvantage is the fact that people may be endangered by splinters and particles in the event of the lamp vessel bursting, which can only be minimized by a protective sleeve known from the general prior art which is applied to the lamp vessel in addition to the pigment underlayers, but which once again absorbs part of the optical radiation and as a result further reduces the efficiency of the fluorescent lamp.

In order to improve the color saturation, it is known from the general prior art in the case of lamps which are subjected to a low thermal load (lamp current<approximately 200 mA), to apply color filter films consisting of a thermoplastic polymer to the outside of the lamp. Although this solution allows for improved color saturation, it is not suitable for lamp types which are subjected to a high load as a result of the filter films which have low thermal resistance (lamp current>approximately 300 mA). Known high-temperature-resistant polymers, such as, for example, tetrafluorethylene/hexafluorpropylene copolymers (FEP) or polyamide (PA), cannot be pigmented in a suitable manner in order to improve the color saturation or have an intrinsic color which is too intensive for such color applications.

### DESCRIPTION OF THE INVENTION

The invention is based on the object of providing a light source in which an efficient light emission with high color saturation and shatterproofness is made possible in comparison with conventional solutions given minimum complexity in terms of apparatus.

This object is achieved by a light source, in particular a fluorescent lamp, with at least one lamp vessel, a high-temperature-resistant silicone rubber being arranged on the lamp vessel, which is provided with at least one pigment influencing the light color and light saturation in order to produce a saturated light color. Particularly advantageous embodiments of the invention are described in the dependent claims.

With the solution according to the invention, it is possible to dispense with pigment underlayers between the lamp vessel and the phosphor layer, in comparison with the prior art, as a result of the high-temperature-resistant silicone rubber provided with a pigment influencing the light color and light saturation, with the result that efficient light emission in the desired spectral region with high color saturation given minimum complexity in terms of apparatus is made possible. Silicone rubber is in this case characterized by ready pigmentability in addition to the thermal stability. The light color and color saturation is in this solution determined by the type of pigments used, possible examples being the saturated light colors red, green, blue and yellow. In the context of the invention, pigments is also understood to mean colorants or filter agents which are soluble in silicone rubber, in addition to pigments which are insoluble in silicone rubber. Owing to the high resilience and the viscoplasticity of the silicone rubber, a shatterproof effect in the event of bursting of the lamp vessel is also achieved, with the result that people being endangered by splinters and particles is effectively prevented. Furthermore, the lamp parts can even be handled once the lamp has burst without any risk to the user as a result of the very resistant silicone rubber. As a result, no additional shatterproof sleeve which absorbs the optical radiation is required, with the result that, according to the invention, shatterproof lamps with improved efficiency are achieved. In addition to the high color saturation, thermal stability and shatterproof effect, the light source according to the invention allows for a luminous flux stability during the operating time which is comparable with conventional three-strip fluorescent lamps. Such light sources are used, for example, in effect lighting for generating color effects, as stage and display window decoration or as party lighting. Furthermore, the lamps can be used advantageously as component lamps in color-adaptive lighting tasks.

It has proven to be particularly advantageous if the pigmented silicone rubber is applied to the lamp vessel in the form of a prefabricated sleeve. The silicone rubber sleeve can in this case be fastened to the lamp vessel in a simple manner in terms of manufacturing using force-fitting technology, for example owing to a slight underdimensioning of the sleeve with respect to the lamp vessel.

In an alternative exemplary embodiment, the silicone rubber is applied to the lamp vessel in an advantageous manner in terms of manufacturing in the form of a coating. For this purpose, for example, a silicone resin can be used, which is applied to the lamp vessel and then cured.

In accordance with a particularly preferred exemplary embodiment of the invention, the pigment introduced into the silicone rubber is an oxidic or nitridic-pigment.

Preferably, an iron oxide compound, for example an Fe₂O₃ compound, is used as the pigment for a light spectrum with a color locus which is substantially in the red region.

A light spectrum with a color locus which is substantially in the yellow region is achieved in a preferred exemplary embodiment by particles which have a nickel/antimony/titanium oxide compound, preferably an NiSbTiO₂ compound.

The silicone rubber sleeve is preferably applied to the lamp vessel in such a way that an outer circumferential area of the lamp vessel is substantially completely covered.

The light source according to the invention can be in the form of, for example, a fluorescent lamp or compact fluorescent lamp, in particular in the form of a high-wattage fluorescent lamp or compact fluorescent lamp which is subjected to a high load.

### BRIEF DESCRIPTION OF THE DRAWING

The invention will be explained in more detail below with reference to a preferred exemplary embodiment. The single FIGURE shows a schematic illustration of a light source according to the invention in the form of a fluorescent lamp.

### PREFERRED EMBODIMENT OF THE INVENTION

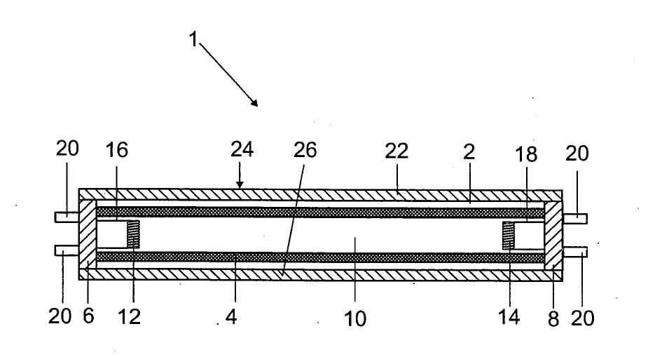

FIG. 1 shows a schematic illustration of a light source according to the invention in the form of a fluorescent lamp 1. Said light source has an approximately rod-shaped or tubular lamp vessel 2 consisting of glass, which is provided with a phosphor layer 4. The lamp vessel 2 has an interior 10, which is sealed off on both sides via base parts 6, 8 and into which two diametrically arranged electrodes 12, 14 (incandescent filaments) protrude, between which a gas discharge is formed during lamp operation.

For electrical contact-making purposes, the electrodes 12, 14 are connected, in each case via power supply lines 16, 18, to contact pins 20 which pass through the base parts 6, 8 and, in conjunction with a corresponding lampholder of a luminaire (not illustrated), enable a stable mechanical hold of the fluorescent lamp 1 and safe electrical contact-making. An ionizable fill is enclosed in the interior 10 of the lamp vessel 2, which fill substantially consists of one or more noble gases and a small quantity of mercury. A high-temperature-resistant silicone rubber 22, which is provided with at least one pigment influencing the light color and light saturation in order to produce a saturated light color, is arranged on the lamp vessel 2. In the exemplary embodiment illustrated, the pigmented silicone rubber 22 is in the form of a prefabricated sleeve 24, is pushed axially onto the lamp vessel 2 and is fastened to the lamp vessel 2 in a force-fitting manner as a result of a slight underdimensioning with respect to said lamp vessel 2. As a result, the silicone sleeve 24 is fixed on the lamp vessel 2 in a manner which is simple in terms of manufacture. The silicone rubber sleeve 24, as shown in the FIGURE, has been pushed onto the lamp vessel 2 in such a way that an outer circumferential area 26 of the lamp vessel 2 is completely covered and the base parts 6, 8 are radially covered. In the exemplary embodiment of the invention illustrated, the pigment introduced into the silicone rubber 22 of the sleeve 24 is an Fe₂O₃ compound. Owing to the high-temperature-resistant silicone sleeve 24 which is provided with an Fe₂O₃ pigment influencing the light color and light saturation, efficient light emission of the fluorescent lamp 1 in the deep-red spectral region with high color saturation given minimum complexity in terms of apparatus is achieved, with the silicone rubber 22 being characterized by ready pigmentability. Such fluorescent lamps 1 are used, for example, in effect lighting for producing color effects, as stage and display window decoration or as party lighting. In addition, the lamps 1 can advantageously be used as component lamps in color-adaptive lighting tasks.

A light spectrum with a color locus in the yellow region is achieved in an exemplary embodiment not illustrated, for example, by means of particles which have a nickel/antimony/titanium oxide compound, in particular an NiSbTiO₂ compound.

Owing to the high resilience and the viscoplasticity of the silicone rubber sleeve 24, a shatterproof effect is furthermore achieved in the case of the lamp vessel 2 bursting, with the result that people being endangered by splinters and particles is effectively prevented. In this case, the lamp parts can even be handled once the lamp has burst without any risk to the user as a result of the very resistant silicone rubber sleeve 24. In addition to the high color saturation, thermal stability and shatterproof effect, the light source according to the invention enables a luminous flux stability during the operating time which is comparable with conventional three-strip fluorescent lamps.

The light source 1 according to the invention is not restricted to the exemplary embodiment illustrated with a sleeve 24 consisting of silicone rubber 22 which has been pushed onto the lamp vessel 2 in prefabricated fashion, but rather the silicone rubber 22 can be applied to the lamp vessel 2 in the form of a coating by means of coating processes known from the prior art. This variant likewise has the advantage that the lamp parts can be handled even once the lamp has burst without any risk to the user as a result of the very resistant silicone rubber 22.

Furthermore, the light source 1 according to the invention is not restricted to the rod-shaped lamp vessel 2 illustrated, but rather the light source 1 can have different lamp vessel shapes known from the prior art, for example the lamp vessel 2 can be U-shaped or annular, in particular the light source 1 can also be in the form of a compact fluorescent lamp with a base at one end or light-emitting diode. Since the light color and color saturation are determined by the type of pigments used, all light colors which can be produced by pigments and are known from the prior art can be realized in addition to the mentioned light colors.

The invention discloses a light source 1, in particular a fluorescent lamp, with at least one lamp vessel 2, a high-temperature-resistant silicone rubber 22 being arranged on the lamp vessel 2, which is provided with at least one pigment influencing the light color and light saturation in order to produce a saturated light color.

1. A light source, in particular a fluorescent lamp, with at least one lamp vessel (2), characterized in that a high-temperature-resistant silicone rubber (22) is arranged on the lamp vessel (2), which is provided with at least one pigment influencing the light color and light saturation in order to produce a saturated light color.

2. The light source as claimed in claim 1, the pigmented silicone rubber (22) being applied to the lamp vessel (2) in the form of a sleeve (24).

3. The light source as claimed in claim 1, the silicone rubber (22) being applied to the lamp vessel (2) in the form of a coating.

4. The light source as claimed in one of the preceding claims, the pigment being an oxidic or nitridic pigment.

5. The light source as claimed in claim 1, the pigment having an iron oxide compound, for a light spectrum with a color locus which is substantially in the red region.

6. The light source as claimed in claim 1, the pigment having a nickel/antimony/titanium oxide compound, for a light spectrum with a color locus which is substantially in the yellow region.

7. The light source as claimed in claim 1, the silicone rubber (22) substantially completely covering an outer circumferential area (26) of the lamp vessel (2).

8. The light source as claimed in claim 1, the light source (1) being a fluorescent lamp or compact fluorescent lamp, in particular a high-wattage fluorescent lamp or compact fluorescent lamp.

9. The light source as claimed in claim 1, the light source (1) being used for effect lighting tasks and/or as a component lamp (1) for color-adaptive lighting tasks.

10. The light source of claim 5 wherein the pigment comprises an Fe₂O₃ compound.

11. The light source of claim 6 wherein the pigment comprises an NiSbTiO₂ compound.
